(19) United States
(12) Patent Application Publication
(10) Pub. No.: US 2024/0075997 A1
(43) Pub. Date: Mar. 7, 2024

(54) SNOW MOBILE TRACK STUD BACKER

(71) Applicant: Dennis Barringer, Boonville, NY (US)

(72) Inventor: Dennis Barringer, Boonville, NY (US)

(21) Appl. No.: 18/459,782

(22) Filed: Sep. 1, 2023

Related U.S. Application Data
(60) Provisional application No. 63/403,967, filed on Sep. 6, 2022.

(51) Int. Cl. B62D 55/28; B62M 27/02

(52) U.S. Cl. CPC B62D 55/286; B62M 27/02; B62M 2027/027

(57) ABSTRACT

A snowmobile stud backer includes a body extending from a backer base, the body narrowing from the base to a narrow end, the body further including an axial opening extending from the backer base to the narrow end, the axial opening including internal threads, the body including a plurality of channels providing a surface within which a tool is configured to be keyed for the purpose of tightening the backer to the stud structure. Further disclosed is a snowmobile stud assembly, a snowmobile track, and a snowmobile, as well as tools for installing the snowmobile stud backer to the snowmobile track.

### RELATED MATTERS

This application claims the benefit of the earlier filing date of U.S. Provisional Patent Application No. 63/403,967 filed Sep. 6, 2022 and titled “SNOW MOBILE TRACK STUD BACKER,” the entirety of which is incorporated by reference.

### TECHNICAL FIELD

The present invention relates to snow mobiles. More particularly, the present invention relates to an improved snow mobile track stud backers.

### BACKGROUND

Flexible snow mobile tracks can be configured to receive studs which may be affixed to the flexible tracks in order to provide additional traction. A stud is typically a metallic nail, pin, peg, or spike, which is configured to penetrate the ground upon which the snow mobile traverses (e.g. snow, ice or the like). Studs can thus increase handling, performance, or even speed of a snowmobile. A stud may be mounted through the track and through a backer, which acts as a washer and stabilizer to prevent the stud from ripping through the track. Typically, a mechanical fastener, such as a nut, is then used to secure the stud and the backer to the flexible track. A tradeoff often exists between the weight or mass of the stud, backer and nut system, and the performance and durability of the stud system.

Thus, a lightweight high performance stud backer that is strong and durable but low in mass would be well received in the art.

### SUMMARY

According to a described aspect, a snowmobile stud assembly comprises: a stud structure including a stud base and a pin extending from the base, the pin including a threaded portion; and a stud backer including a body extending from a backer base, the body narrowing from the base to a narrow end, the body further including an axial opening extending from the backer base to the narrow end, the axial opening including internal threads, the body including a plurality of channels providing a surface within which a tool is configured to be keyed for the purpose of tightening the backer to the stud structure.

According to another described aspect, a snowmobile stud backer comprises: a body extending from a backer base, the body narrowing from the base to a narrow end, the body further including an axial opening extending from the backer base to the narrow end, the axial opening including internal threads, the body including a plurality of channels providing a surface within which a tool is configured to be keyed for the purpose of tightening the backer to the stud structure.

According to another described aspect, a snowmobile track comprises: a track configured to rotate about idler wheels and a track driver of a snowmobile; and a stud assembly connected to the track of the snowmobile, the stud assembly including: a stud structure including a stud base and a pin extending from the base, the pin including a threaded portion; and a stud backer including a body extending from a backer base, the body narrowing from the base to a narrow end, the body further including an axial opening extending from the backer base to the narrow end, the axial opening including internal threads, the body including a plurality of channels providing a surface within which a tool is configured to be keyed for the purpose of tightening the backer to the stud structure, wherein the pin of the stud extends through an opening of the track, and wherein the stud backer is attached to the stud such that the track is located between the stud base and the backer base.

### BRIEF DESCRIPTION OF THE DRAWINGS

Some of the embodiments will be described in detail with references made to the following figures, wherein like designations denote like members, wherein:

FIG. 1 depicts a side view of a snow mobile having a track and a stud assembly, according to one embodiment.

FIG. 2A depicts a perspective view of a stud prior to attaching a pin to a base, according to one embodiment.

FIG. 2B depicts a perspective view of the stud of FIG. 2A after attachment according to one embodiment.

FIG. 3A depicts a perspective view of a backer for attachment to the stud of FIGS. 2A and 2B, according to one embodiment.

FIG. 3B depicts a side view of the backer of FIG. 3A, according to one embodiment.

FIG. 3C depicts a top view of the backer of FIGS. 3A and 3B, according to one embodiment.

FIG. 3D depicts a bottom view of the backer of FIGS. 3A-3C, according to one embodiment.

FIG. 3E depicts a cutaway view of the backer of FIGS. 3A-3D, taken at arrows A-A, according to one embodiment.

FIG. 3F depicts an enlarged view of the backer of FIGS. 3A-3E, taken at detail B, according to one embodiment.

FIG. 4A depicts a perspective view of another backer, according to one embodiment.

FIG. 4B depicts a bottom view of the backer of FIG. 4A, according to one embodiment.

FIG. 5A depicts a perspective view of still another backer, according to one embodiment.

FIG. 5B depicts a bottom view of the backer of FIG. 5A, according to one embodiment.

FIG. 6A depicts a tool for attaching the backers of FIGS. 3A-5 to the stud of FIGS. 2A-2B, according to one embodiment.

FIG. 6B depicts a top view of the tool of FIG. 6A, according to one embodiment.

FIG. 6C depicts an enlarged view of the tool of FIGS. 6A and 6B, taken at detail A, according to one embodiment.

FIG. 7 depicts a perspective view of a backer stud assembly including the backer of FIGS. 3A-3F and the tool of FIGS. 6A-6C, according to one embodiment.

FIG. 8A depicts a front perspective view of a socket tool for attaching the backers of FIGS. 3A-5, according to one embodiment.

FIG. 8B depicts a back perspective view of the socket tool of FIG. 8A, according to one embodiment.

### DETAILED DESCRIPTION

A detailed description of the hereinafter-described embodiments of the disclosed apparatus and method are presented herein by way of exemplification and not limitation with reference made to the Figures. Although certain embodiments are shown and described in detail, it should be understood that various changes and modifications might be made without departing from the scope of the appended claims. The scope of the present disclosure will in no way be limited to the number of constituting components, the materials thereof, the shapes thereof, colors thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

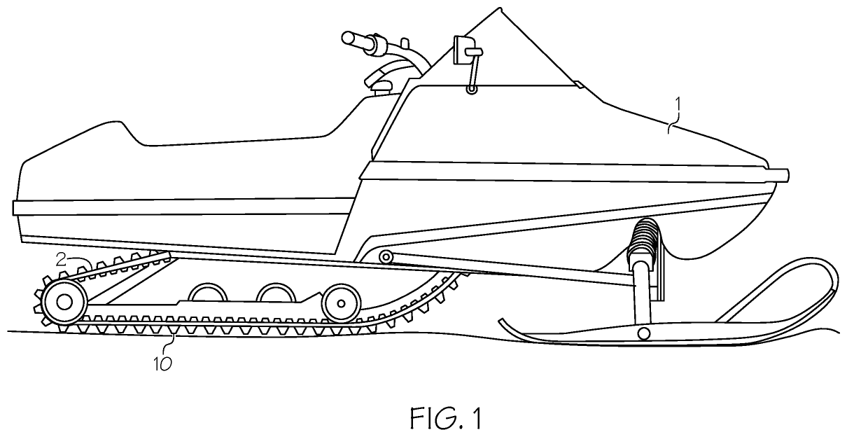

FIG. 1 depicts a side view of a snow mobile 1 having a track 2 and a stud assembly 10, according to one embodiment. The stud assembly 10 may be removably connected to the track 2 of the snowmobile 1. The track 2 may be a flexible track configured to rotate about the idler wheels and track driver of the snowmobile 1. The stud assembly 10 is configured to provide traction to the flexible track 2 such that the flexible track 2 can more efficiently move the snowmobile 1 over various terrain, such as snow, ice or the like.

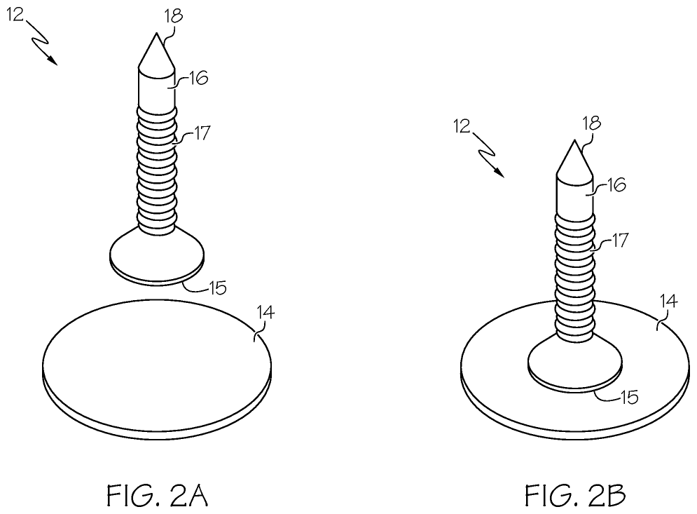

FIG. 2A depicts a perspective view of a stud 12 prior to attaching a pin 16 to a base 14, according to one embodiment. FIG. 2B depicts a perspective view of the stud 12 of FIG. 2A after attachment according to one embodiment. The stud 12 may be made of two separate components which are attached together during a manufacturing process, as shown in FIG. 2A. In particular, the stud 12 includes the base 14 and the pin 16, which may be fuse welded together, for example, with a flat surface of the base 14 welded to a flat surface 15 at the end of the pin 16. While fuse welding is contemplated in order to form the stud 12 as shown in FIG. 2B, other manufacturing processes are contemplated. Whatever the embodiment, the stud 12 may extend between a first end and a second end. The first end may include a tip 18. The tip 18 may be a spiked or pointed end, which may be configured to dig into the surface over which the snowmobile 1 is traversing. The tip 18 may be coated with a carbide coating, in order to reduce wear at the contact point.

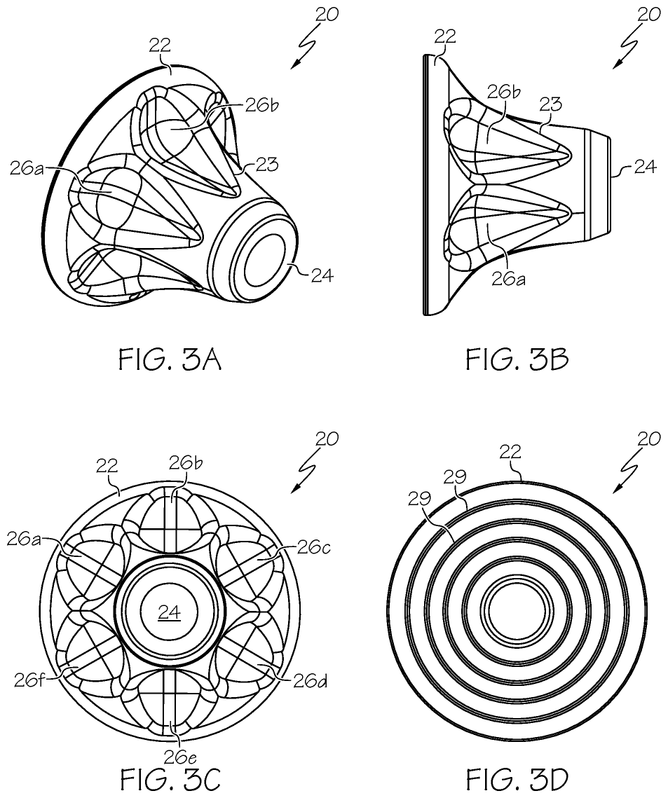

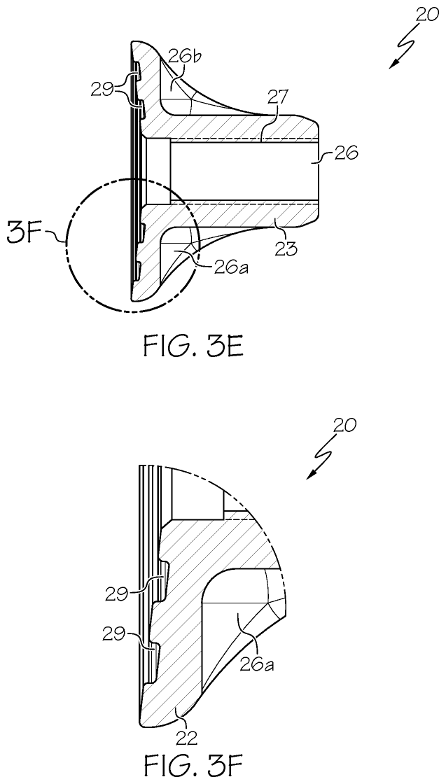

The pin 16 may further include a threaded portion 17 extending between the first and second ends. The threaded portion 17 may comprise the majority of the pin 16. However, in various embodiments, the length of the threaded portion 17 may correspond to the amount of the pin 16 necessary to interface with a backer device 20 (shown in FIGS. 3A-3F). Thus, the threaded portion 17 may be located at the second end of the pin 16, as shown. In other embodiments, the threaded portion 17 may be closer to the first end. Whatever the embodiment, the pin 16 may include external threads which are configured to interface with internal threads of a backer 20 (shown in FIGS. 3A-3F).

FIG. 3A depicts a perspective view of a backer 20 for attachment to the stud 12 of FIGS. 2A and 2B, according to one embodiment. FIG. 3B depicts a side view of the backer 20 of FIG. 3A, according to one embodiment. FIG. 3C depicts a top view of the backer 20 of FIGS. 3A and 3B, according to one embodiment. FIG. 3D depicts a bottom view of the backer 20 of FIGS. 3A-3C, according to one embodiment. FIG. 3E depicts a cutaway view of the backer 20 of FIGS. 3A-3D, taken at arrows A-A, according to one embodiment. FIG. 3F depicts an enlarged view of the backer 20 of FIGS. 3A-3E, taken at detail B, according to one embodiment.

The backer 20 includes a generally circular base 22. Extending from the base 22 is a body 23 which narrows as it approaches a narrow end. The backer 20 includes an axial opening 24 which is configured to receive the pin 16 of the stud 12. In particular, as shown in the cutaway view of FIG. 3E, the axial opening 24 includes internal threads 27 which are configured to receive the external threaded portion 17 of the pin 16 of the stud 12.

The backer 20 further includes a plurality of channels 26a, 26b, 26c, 26d, 26e, 26f. In particular, the plurality of channels 26a, 26b, 26c, 26d, 26e, 26f may comprise six channels, cuts outs, or the like, but the disclosure is not limited to this number. More or less channels are contemplated. The channels 26a, 26b, 26c, 26d, 26e, 26f may provide a surface within which a tool may be keyed for the purpose of tightening the backer 20 to the stud 12. Rather than including a hexagonal shaped base, the channels 26a, 26b, 26c, 26d, 26e, 26f actually remove material from the structure of the backer 20 in order to reduce mass and weight for the backer 20. Because rotating mass on the track reduces the amount of horsepower left to move the vehicle, the channels 26a, 26b, 26c, 26d, 26e, 26f may provide for better horsepower while remaining tough and durable.

As shown in FIGS. 3D and 3F, the backer 20 includes an underside of the base having alternating channels 29 and protrusions, which are configured to better grip the track 2 of the snowmobile 1 when the stud assembly 10 is connected. While five separate circumferential channels 29 are shown, other embodiments may include more or less channels. In some embodiments, there may be no channels but instead the bottom of the backer may be flat.

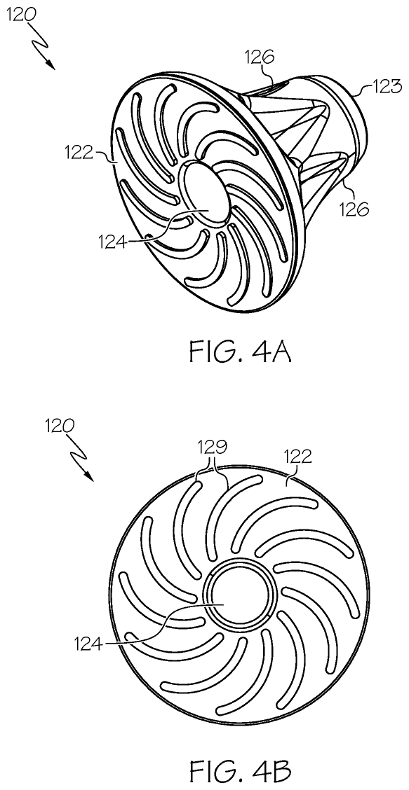

FIG. 4A depicts a perspective view of another backer 120, according to one embodiment. The backer 120 may include the same general structure as the backer 20, including a generally circular base 122, a body 123 which narrows as it approaches a narrow end, and an axial opening 124 configured to receive the pin 16 of the stud 12. The backer 120 includes a plurality of channels 126 which may be the same as the channels 26a, 26b, 26c, 26d, 26e, 26f of the backer 20.

FIG. 4B depicts a bottom view of the backer 120 of FIG. 4A, according to one embodiment. Unlike the backer 20, the backer 120 includes an underside which includes a plurality of protrusions 129. The protrusions 129 form an array of curved swirls radially extending from the center inner axis and the axial opening 124 to the outer circumference. While the protrusions 129 are shown extending as projections from the bottom or underside of the backer 120, in other embodiments, the same swirl pattern may be formed with channels. Whatever the embodiment, the protrusions 129 may be configured to aid in gripping the backer 120 to a snowmobile track 2 when assembled as described.

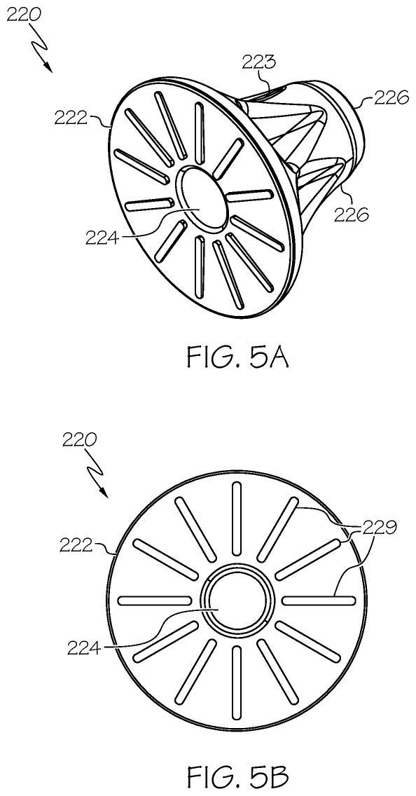

FIG. 5A depicts a perspective view of still another backer 220, according to one embodiment. The backer 220 may include the same general structure as the backer 20, including a generally circular base 222, a body 223 which narrows as it approaches a narrow end, and an axial opening 224 configured to receive the pin 16 of the stud 12. The backer 220 includes a plurality of channels 226 which may be the same as the channels 26a, 26b, 26c, 26d, 26e, 26f of the backer 20.

FIG. 5B depicts a bottom view of the backer 220 of FIG. 5A, according to one embodiment. Unlike the backer 20, the backer 120 includes an underside which includes a plurality of protrusions 229. The protrusions 229 form an array of straight projections extending from the center inner axis and the axial opening 124 to the outer circumference. While the protrusions 129 are shown extending as projections from the bottom or underside of the backer 120, in other embodiments, the same pattern may be formed with channels. Whatever the embodiment, the protrusions 229 may be configured to aid in gripping the backer 120 to a snowmobile track 2 when assembled as described.

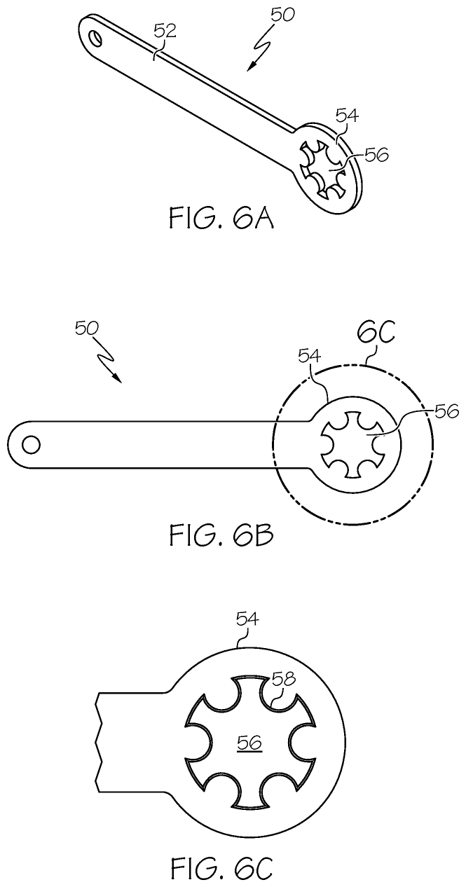

FIG. 6A depicts a tool 50 for attaching the backers 20, 120, 220 of FIGS. 3A-5B to the stud 12 of FIGS. 2A-2B according to one embodiment. FIG. 6B depicts a top view of the tool 50 of FIG. 6A, according to one embodiment. FIG. 6C depicts an enlarged view of the tool 50 of FIGS. 6A and 6B, taken at arrows A-A, according to one embodiment. The tool 50 includes a handle 52 configured to provide leverage for turning the backer 20 about the pin 16 of the stud 12. The handle 52 is shown as a flat handle such that the entire tool 50 may be made from a single sheet of material (such as metal, a composite, a plastic or the like). In other embodiment, the handle 52 may include any particular features, ergonomic dimensions or the like.

The tool 50 includes an interfacing end 54, which may be generally circular in shape. The interfacing end 54 includes an opening 56. The opening 56 may include a plurality of projections 58 which may be keyed to the dimensions of the channels 26a-26f of the backer 20. Thus, each of the projections 58 may fit into one of the channels 26a-26f of the backer 20 in order to grip the backer 20 and allow the tool 50 to provide a torque to rotate the backer 20 about the stud 12. Thus, the opening 56 is shown generally circular in shape, but having six separate U-shaped projections 58 spaced evenly about the circumference of the opening 56 and extending into the circumference of the opening 56.

Referring back to FIG. 1, the stud assembly 10 includes the combination of the stud 12 of FIGS. 2A-2B and the backer 20 of FIGS. 3A-3F. While not shown, the backers 120, 220 may be attached to create a stud assembly 10 in the same manner. To assemble the stud assembly 10 to a snowmobile track 2, the stud 12 is inserted through the backside of the track 2. The backer 20 is then screwed onto the external threads 17 of the stud 12, thereby completing the stud assembly 10. In order to screw the backer 20 to the stud 12, the tool 50 may be used. In particular, the opening 56 of the tool 50 may be aligned with backer 20 such that the projections 58 are inserted into the channels 26a, 26f of the backer 20. The user may then torque, rotate or otherwise twist the backer 20 with the tool 50, and repeat this process until the backer 20 is tightly attached to the stud 12 with the body of the track 2 located between the base 22 of the backer 20 and the base 14 of the stud 12.

The backers 20, 120, 220 described herein and/or the stud 12 can each be made of a metallic material such as aluminum, or steel. Alternatively, while the stud 12 may be made of metal, the backers 20, 120, 220 can be made of a composite, plastic, or any other suitable, lightweight, yet strong material. Further, the stud assembly 10 can be formed of a two-piece construction, comprising the stud 12 and one of the backers 20, 120, 220. The stud assembly 10 thereby provides a lightweight and strong solution for providing grip or traction to the track 2. The stud 12 may be a 1.75 inch stud in one embodiment. However, any length stud is contemplated.

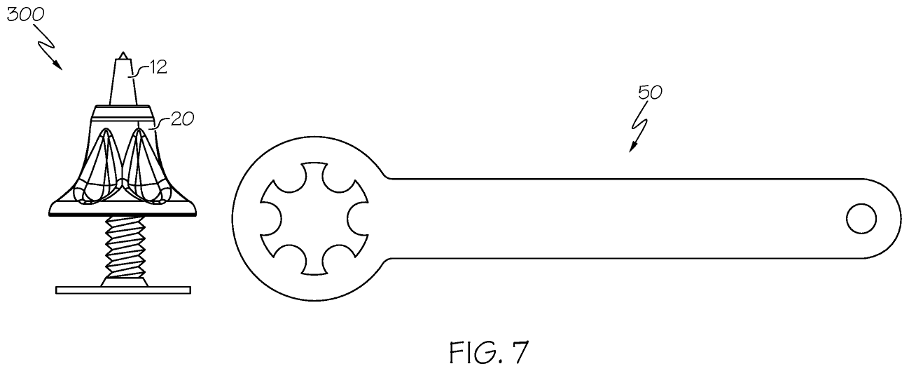

FIG. 7 depicts a perspective view of a stud assembly 300 and the tool 50 of FIGS. 4A-4C, according to one embodiment. The stud assembly 300 includes the backer 20 of FIGS. 3A-3F, as well as the stud 12 of FIGS. 2A-2B after the backer 20 is threadably attached to the stud 12. While not shown, any of the backers 120, 220 may be threadably attached to create a stud assembly as shown. In practice, the space between the backer 20 and the stud 12 shown in FIG. 7 will be filled, at least in part, by the track 2 of a snowmobile.

The view in FIG. 7 further illustrates a configuration of the relative size between a backer, such as the backer 20, 120, 220, and the tightening tool 50. However, the tightening tool 50 is not the only tightening tool which may accomplish tightening of the backer 20, 120, 220 to a stud.

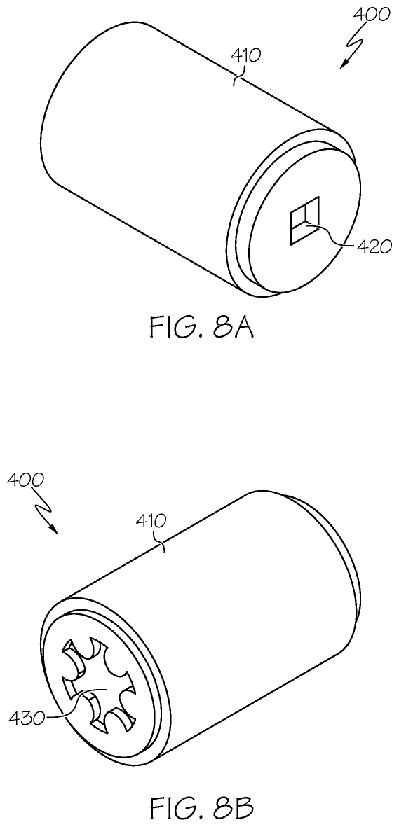

FIG. 8A depicts a front perspective view of a socket tool 400 for attaching the backers 20, 120, 220 of FIGS. 3A-5B, according to one embodiment. FIG. 8B depicts a back perspective view of the socket tool 300 of FIG. 8A, according to one embodiment. At a first end (shown in FIG. 8A), the socket tool 400 may include a ratchet tool opening 420 configured to receive a square-drive connector of a standard ratchet tool (not shown). On an opposite end (shown in FIG. 8B), the socket tool 400 may include an interface opening 430 having a plurality of projections (i.e. in a 6-prong star shape) which may be keyed to the dimensions of the channels 26a-26f of the backer 20, and/or the channels 126, 226 of the backers 120, 220, respectively. In practice, the socket tool 400, when attached to a ratchet, can operate in a similar manner to the tool 50 in order to tighten the backer 20, 120, 220 to the stud 12 to create the stud assembly 300, as shown in FIG. 7.

Thus, as described above, the stud assembly 10 may comprise a one piece backer design, where there is no separate washer and tightening nut. Rather, the present invention proposes a one piece backer 20, 120, 220 which attaches to a one piece stud 12 without a male hex, but rather with a female nut having cutouts for weight reduction. A customized tool 50, or socket tool 300, has also been proposed for rotating the female nut of the backer 20, 120, 220.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

I claim:

1. A snowmobile stud assembly comprising:
a stud structure including a stud base and a pin extending from the base, the pin including a threaded portion; and
a stud backer including a body extending from a backer base, the body narrowing from the base to a narrow end, the body further including an axial opening extending from the backer base to the narrow end, the axial opening including internal threads, the body including a plurality of channels providing a surface within which a tool is configured to be keyed for the purpose of tightening the backer to the stud structure.

2. The snowmobile stud assembly of claim 1, wherein each of the plurality of channels remove material from the structure of the backer and are configured to reduce mass and weight of the backer.

3. The snowmobile stud assembly of claim 2, wherein each of the plurality of channels extend down from the narrow end to the backer base, and wherein the backer base defines a bottom structure of each of the plurality of channels.

4. The snowmobile stud assembly of claim 3, wherein the plurality of channels includes six channels.

5. The snowmobile stud assembly of claim 4, wherein the stud backer is made of plastic.

6. The snowmobile stud assembly of claim 5, wherein the stud structure is made of metal.

7. The snowmobile stud assembly of claim 6, wherein the pin extends to a pointed end, wherein the pointed end is configured to dig into the surface over which a snow mobile is traversing.

8. The snowmobile stud assembly of claim 1, wherein a bottom surface of the stud backer includes at least one of a plurality of channels and a plurality of projections.

9. The snowmobile stud assembly of claim 8, wherein the stud backer includes the plurality of projections configured to grip a track of a snow mobile when the snow mobile stud assembly is attached to the track of the snow mobile.

10. A snowmobile stud backer comprising:
a body extending from a backer base, the body narrowing from the base to a narrow end, the body further including an axial opening extending from the backer base to the narrow end, the axial opening including internal threads, the body including a plurality of channels providing a surface within which a tool is configured to be keyed for the purpose of tightening the backer to the stud structure.

11. The snowmobile stud backer of claim 10, wherein each of the plurality of channels remove material from the structure of the backer and are configured to reduce mass and weight of the backer.

12. The snowmobile stud backer of claim 11, wherein each of the plurality of channels extend down from the narrow end to the backer base, and wherein the backer base defines a bottom structure of each of the plurality of channels.

13. The snowmobile stud backer of claim 12, wherein the plurality of channels includes six channels.

14. The snowmobile stud backer of claim 13, wherein the stud backer is made of plastic.

15. The snowmobile stud assembly of claim 14, wherein a bottom surface of the stud backer includes at last one of a plurality of channels and a plurality of projections.

16. The snowmobile stud assembly of claim 15, wherein the stud backer includes the plurality of projections configured to grip a track of a snow mobile when the snow mobile stud assembly is attached to the track of the snow mobile.

17. A snowmobile track comprising:
a track configured to rotate about idler wheels and a track driver of a snowmobile; and
a stud assembly connected to the track of the snowmobile, the stud assembly including:
a stud structure including a stud base and a pin extending from the base, the pin including a threaded portion; and
a stud backer including a body extending from a backer base, the body narrowing from the base to a narrow end, the body further including an axial opening extending from the backer base to the narrow end, the axial opening including internal threads, the body including a plurality of channels providing a surface within which a tool is configured to be keyed for the purpose of tightening the backer to the stud structure,
wherein the pin of the stud extends through an opening of the track, and wherein the stud backer is attached to the stud such that the track is located between the stud base and the backer base.

18. The snowmobile track of claim 17, further comprising an array of a plurality of the study assemblies connected to the track of the snowmobile.

19. The snowmobile track of claim 18, wherein the stud backer is made of plastic and wherein the stud structure is made of metal.

20. The snowmobile track of claim 19, wherein a bottom surface of the each of the plurality of stud backers includes at least one of a plurality of channels and a plurality of projections, and wherein the at least one of the plurality of channels and the plurality of projections are configured to grip the track and prevent rotation of the stud backers about the stud structure.
